(19) United States
(12) Patent Application Publication
(10) Pub. No.: US 2012/0153698 A1
(43) Pub. Date: Jun. 21, 2012

(54) RECLINING APPARATUS

(75) Inventor: Yoshitaka ISHIHARA, Aichi (JP)

(73) Assignee: IMASEN ELECTRIC INDUSTRIAL CO., LTD., Aichi (JP)

(21) Appl. No.: 12/974,380

(22) Filed: Dec. 21, 2010

(51) Int. Cl. B60N 2/22

(52) U.S. Cl. 297/362

(57) ABSTRACT

An object of an aspect according to the present invention is to provide a reclining apparatus capable of reducing the cost. A center shaft of the reclining apparatus is inserted through through-holes respectively bored at the center portions of a base plate and a gear plate. The center shaft coaxially and pivotally supports the base plate and the gear plate. An annular protrusion provided at the center shaft is sandwiched between the base plate of the reclining apparatus and a bracket on a seat side. This prevents the center shaft from coming off.

### CROSS-REFERENCE TO RELATED APPLICATION

This application is based on Japanese Patent Application No. 2009-202135 filed with the Japan Patent Office on Sep. 1, 2009, the entire content of which is hereby incorporated by reference.

### BACKGROUND

1. Technical Field

The present invention relates to a reclining apparatus for a vehicle seat, and particularly to its component members.

2. Related Art

A vehicle seat generally includes various adjusting mechanisms to fit the seat to an occupant's body shape or driving posture. Among them, a reclining apparatus for adjusting an angle of a seat back with respect to a seat cushion is the most basic adjusting mechanism.

There are two types of the reclining apparatus, i.e., a power type operated by power of an electric motor and a manual type operated manually by an occupant. Especially, the apparatus of the latter type has a small risk of failure and can be manufactured at low cost as it is simpler in structure than the power type.

As the manual type reclining apparatus, a so-called internal gear type reclining apparatus is known (e.g., refer to Japanese Patent No. 4305571). In this apparatus, a seat back is biased in one direction by a spring, and is locked by, for example, mesh of an internal gear provided at the seat back with an external gear provided at a seat cushion and detachable from the internal gear. When the seat back is to be inclined, an occupant rotates a center shaft interlocking with the external gear to release the mesh between the internal gear and the external gear. Accordingly, the seat back is inclined by the biasing force of the spring.

### SUMMARY

However, in the aforementioned conventional reclining apparatus, a washer is used to prevent the center shaft from coming off. Thus, a process for attaching the washer is needed separately. Also, since the number of parts is increased, the carrying efficiency is lowered. In this manner, the conventional apparatus may have difficulty in reducing the cost as it requires the washer.

An object of an aspect according to the present invention is to provide a reclining apparatus capable of reducing the cost.

A reclining apparatus according to an aspect of the present invention is a reclining apparatus which adjusts an angle of a seat back with respect to a seat cushion, including a base plate fixed on a bracket of either the seat back or the seat cushion, a gear mechanism which fixes the seat back to the seat cushion, and a center shaft extending through the base plate and the gear mechanism to control fixing of the seat back by the gear mechanism and its release, wherein the center shaft has an annular protrusion arranged to be sandwiched between the base plate and the bracket.

### BRIEF DESCRIPTION OF THE DRAWINGS

The foregoing and other objects, features, aspects and advantages of the invention will become more apparent from the following detailed description when taken in conjunction with the accompanying drawings, in which:

FIG. 1A is a view showing a state where reclining is locked in a reclining apparatus according to an aspect of the present invention and is a cross-sectional view along the line D-D in FIG. 1B;

FIG. 1B is a cross-sectional view of the reclining apparatus along the line C-C in FIG. 1A; and

FIG. 2 is a view showing a vehicle seat to which the reclining apparatus is attached.

### DESCRIPTION OF EMBODIMENTS

Preferred embodiments of the present invention will be described below with reference to the accompanying drawings, in which like reference characters designate similar or identical parts throughout the several views thereof.

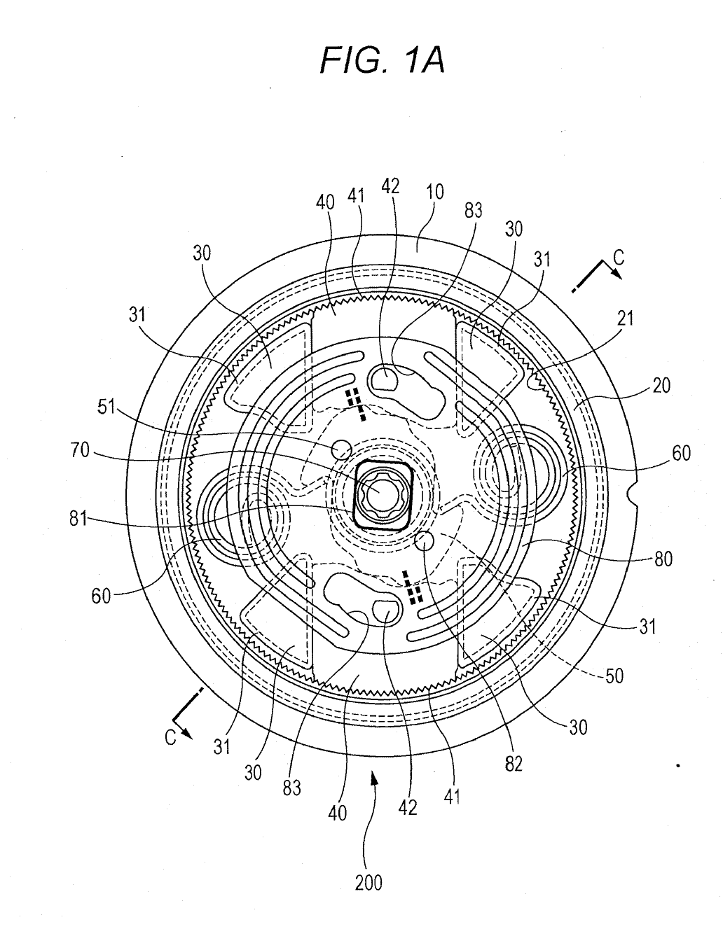

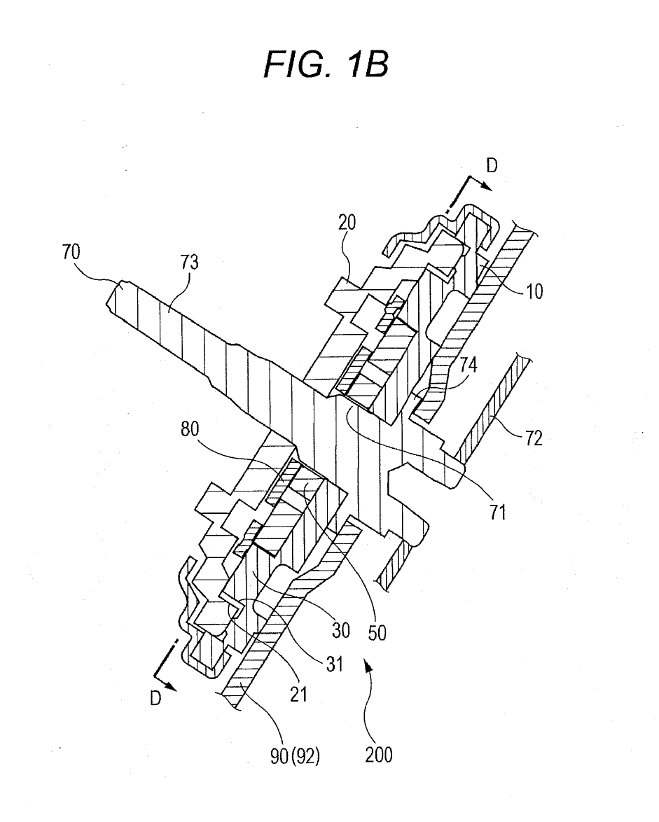

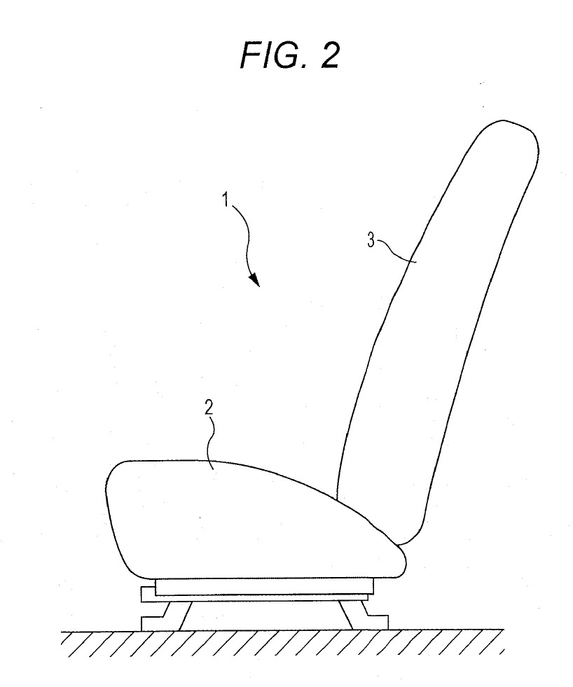

FIG. 1A is a view showing a state where reclining is locked in a reclining apparatus 200 according to an aspect of the present invention and is a cross-sectional view along the line D-D in FIG. 1B. FIG. 1B is a cross-sectional view of the reclining apparatus 200 along the line C-C in FIG. 1A. FIG. 2 is a view showing a vehicle seat 1 to which the reclining apparatus 200 is attached.

As shown in FIGS. 1A and 1B, the reclining apparatus 200 according to the present embodiment has “a base plate 10,” “a gear plate (gear mechanism) 20,” “a fixing guide (gear mechanism) 30,” “a lock gear (gear mechanism) 40,” “a cam (gear mechanism) 50,” “a spring (gear mechanism) 60,” “a center shaft 70,” and “a link plate 80.” Hereinafter, the respective components will be described.

First, “the base plate 10” constitutes a base table of the reclining apparatus 200. This base plate 10 is fixed either on a seat cushion 2 or on a seat back 3 in the vehicle seat 1 shown in FIG. 2. The base plate 10 preferably has strength sufficient to support the load of the seat back 3 and the weight of an occupant. Thus, the base plate 10 is preferably formed by press work or cutting work of a steel plate. In the present embodiment, the base plate 10 is formed by press work of a steel plate. By this press work, the outline of the base plate 10 is formed in a circular shape, and an after-mentioned fixing guide 30 is formed. Also, in the present embodiment, the base plate 10 is fixed on a bracket 90 of the seat cushion 2.

Next, “the gear plate 20” is fixed either on the seat cushion 2 or on the seat back 3 (the other one on which the base plate 10 is not fixed) in the vehicle seat 1. The gear plate 20 is rotatably attached to the aforementioned base plate 10. At the inner circumference of a surface opposite a surface fixed on the seat back 3 (or the seat cushion 2) in the gear plate 20 is formed “an internal gear 21.” The internal gear 21 can be meshed with an external gear 41 of an after-mentioned lock gear 40. The internal gear 21 is meshed with the external gear 41 of the lock gear 40 to lock movement of the seat back 3 in the front-back direction. The gear plate 20 preferably has strength sufficient to support the load of the seat back 3 and the weight of the occupant. Thus, the gear plate 20 is preferably formed by press work or cutting work of a steel plate. In the present embodiment, the gear plate 20 is foamed by press work of a steel plate. By this press work, the outline of the gear plate 20 is formed in a circular shape, and the internal gear 21 is formed. Also, in the present embodiment, the gear plate 20 is fixed on the seat back 3.

Also, as for “the fixing guide 30,” a pair thereof is provided at each of two eccentric locations on the aforementioned base plate 10 so as to be integral with the base plate 10. Each of the two pairs of fixing guides 30 sandwiches the after-mentioned lock gear 40. The fixing guide 30 receives the load of the seat back 3 and the weight of the occupant in a concentrated manner. Therefore, the fixing guide 30 preferably has strength sufficient to support the loads. Thus, the fixing guide 30 is preferably formed by press work or cutting work of a steel plate. In the present embodiment, the fixing guide 30 is formed, during forming of the base plate 10 by the press work of a steel plate, by pushing out and projecting a part of the steel plate with a die from the back side.

It is to be noted that the mechanical strength of the fixing guide 30 is preferably set lower than those of the aforementioned gear plate 20 and the after-mentioned lock gear 40. In such setting, when a large load is input to the reclining apparatus 200 (in an emergency), the fixing guide 30 will be thrust and deformed by the lock gear 40. This will enable an outer end portion 31 of the fixing guide 30 to abut on the internal gear 21 of the gear plate 20.

It is to be also noted that the fixing guide 30 is preferably provided so that the outer end portion 31 of the fixing guide 30 and the tip end of the internal gear 21 of the gear plate 20 may approach each other as much as possible. Such a configuration will enable the outer end portion 31 to dig into the internal gear 21 of the gear plate 20 more reliably when the fixing guide 30 is deformed.

It is to be further noted that the fixing guide 30 is preferably formed to have a thickness allowing the fixing guide 30 and the gear plate 20 to be substantially in a close contact state when the base plate 10 and the gear plate 20 are attached to each other. When the fixing guide 30 is deformed, such a configuration can suppress the deformation in its thickness direction by the gear plate 20. Accordingly, most of the deformation amount of the fixing guide 30 can be appropriated for the digging into the internal gear 21 of the gear plate 20.

“The lock gear 40” has both side surfaces formed in parallel with each other. The lock gear 40 is formed to be slidable between the pair of fixing guides 30 by these side surfaces. The lock gear 40 also has “the external gear 41” formed at one side connecting both the side surfaces. The external gear 41 can be meshed with the internal gear 21 of the gear plate 20. The lock gear 40 will primarily bear the load from the gear plate 20 when its external gear 41 is meshed with the internal gear 21 of the gear plate 20. The lock gear 40 is preferably formed to have strength sufficient to bear such a load. Thus, the lock gear 40 is preferably formed by forging, or by formation of a base material by press work or cutting work of a steel plate followed by hardening of the base material. In the present embodiment, the lock gear 40 is formed by hardening of a pressed steel plate. The lock gear 40 is also provided with a projection 42 to enable coupling with the after-mentioned link plate 80.

“The cam 50” is arranged substantially at the center position of the base plate 10. The after-mentioned shaft 70 is inserted through the cam 50. The cam 50 is rotated simultaneously with the shaft 70 to control movement (slide) of the lock gear 40. That is, the rotation of the cam 50 meshes the lock gear 40 with the gear plate 20 and releases the mesh. This locks movement of the seat back 3 of the seat 1 equipped with the reclining apparatus 200 in the front-back direction and releases the lock. In the present embodiment, the cam 50 has a square hole 52 bored therein and two projections 51. The square hole 52 is a hole enabling a prismatic column 71 of the after-mentioned center shaft 70 to be inserted therethrough. Also, the projections 51 are adapted to enable coupling with the after-mentioned link plate 80.

“The spring 60” biases, and thus rotates, the cam 50 to thrust the lock gear 40 outward. In this manner, the spring 60 keeps a state where the lock gear 40 is meshed with the internal gear 21 of the gear plate 20. In the present embodiment, a spiral spring 60 is adopted as the spring 60. One end of the spring 60 is engaged with the aforementioned cam 50 while the other end is engaged with an engaging projection projecting from the base plate 10. It is to be noted that the spring 60 may be attached to the after-mentioned center shaft 70 (not shown). In this configuration, the spring 60 biases, and thus rotates, the cam 50 via the center shaft 70 to keep the state where the lock gear 40 is meshed with the internal gear 21 of the gear plate 20.

“The center shaft 70” is inserted through through-holes respectively bored at the center portions of the base plate 10 and the gear plate 20. In this manner, the center shaft 70 coaxially and pivotally supports the base plate 10 and the gear plate 20. Also, the center shaft 70 is provided with “a manipulation lever 72” as a separate member. When an occupant manually manipulates the manipulation lever 72, the cam 50 and the link plate 80 inserted between the base plate 10 and the gear plate 20 are rotated simultaneously. This brings about the mesh of the lock gear 40 with the gear plate 20 or release of the mesh. In the present embodiment, the center shaft 70 is formed by cutting work of a steel material. More specifically, substantially around the center portion of the center shaft 70 is provided the prismatic column 71 that can be inserted through the square hole 52 formed in the cam 50 and a square hole 81 formed in the link plate 80. One end of the center shaft 70 is configured to receive the manipulation lever 72 thereat. The other end of the center shaft 70 has formed thereat a serration 73 to enable coupling with a coupling shaft (not shown). This is because the reclining apparatuses 200 are mounted at coupling portions on both the right and left sides of the vehicle seat 1, and rotation of the cam 50 in the reclining apparatus 200 on the left side of the seat 1 and rotation of the cam 50 in the reclining apparatus 200 on the right side of the seat 1 are preferably synchronized via the coupling shaft.

Also, the center shaft 70 is provided with an annular protrusion 74. The annular protrusion 74 is configured to be sandwiched between the base plate 10 of the reclining apparatus 200 and the bracket 90 of the seat cushion 2. This prevents the center shaft 70 from coming off from the reclining apparatus 200. Due to this configuration, it is possible to attach the center shaft 70 to the reclining apparatus 200 without using additional parts such as a washer.

“The link plate 80” is rotated simultaneously with the cam 50 when mesh of the lock gear 40 with the internal gear 21 of the gear plate 20 is released as a result of the rotation of the cam 50. In this manner, the link plate 80 pulls the lock gear 40 inward. In the present embodiment, the link plate 80 is made of a thin plate and is formed substantially in a circular shape. At the center position of the link plate 80 is bored the square hole 81 through which the prismatic column 71 of the center shaft 70 can be inserted. Also, on the outer side of the square hole 81 of the link plate 80 is bored a round hole 82 through which the projection 51 of the cam 50 can be inserted. Further, in the link plate 80 is bored an elongated hole 83 through which the projection 42 of the lock gear 40 can be inserted.

Subsequently, operations of the reclining apparatus 200 according to the present embodiment constituted as above will be described.

First, in this reclining apparatus 200, when movement of the seat back 3 in the front-back direction is to be locked, an occupant opens the manipulation lever 72. When the manipulation lever 72 is opened, the cam 50, which is biased in a clockwise direction in FIG. 1A by the spring 60, is rotated by the biasing force. Accordingly, the lock gear 40 slides to be pushed outward on the base plate 10 along the fixing guides 30. Then, the external gear 41 of the lock gear 40 is meshed with the internal gear 21 at the inner circumference of the gear plate 20. As a result, movement of the seat back 3 in the front-back direction is locked.

On the other hand, in a case where the lock of movement of the seat back 3 in the front-back direction is to be released in the reclining apparatus 200, the occupant turns the manipulation lever 72 to pull it up (or push it down). By this turning, the center shaft 70 equipped with the manipulation lever 72 is rotated in a counterclockwise direction. In addition, the cam 50 and the link plate 80 through which the center shaft 70 is inserted are rotated simultaneously. The rotation of the cam 50 generates a space between the cam 50 and the lock gear 40. At this time, however, the rotation of the link plate 80 causes the outside edge of its elongated hole 83 to abut on the projection 42 of the lock gear 40. Thus, since the lock gear 40 is smoothly pulled inward, the aforementioned space will be filled. When the lock gear 40 is pulled inward, the seat back 3 is ready to be moved in the front-back direction. These sequential operations progress almost simultaneously.

Meanwhile, in the present embodiment, the base plate 10 is fixed on the bracket 90 of the seat cushion 2 while the gear plate 20 is fixed on the seat back 3. Alternatively, however, the base plate 10 may be fixed on a bracket 92 (refer to FIG. 1B) on the seat back 3 side while the gear plate 20 may be fixed on the seat cushion 2.

As described above, the reclining apparatus 200 according to one aspect of the present invention includes the base plate 10 fixed on either one of the brackets 90 and 92 of the seat cushion 2 and the seat back 3, the gear mechanisms (20, 30, 40, 50, 60) fixing the seat back 3 to the seat cushion 2, and the center shaft 70 extending through the base plate 10 and the gear mechanisms to control fixing of the seat back 3 by the gear mechanisms and its release. This center shaft 70 has the annular protrusion 74 arranged to be sandwiched between the base plate 10 and the bracket 90 (92).

In the reclining apparatus 200, the annular protrusion 74 provided at the center shaft 70 is arranged to be sandwiched between the base plate 10 and the bracket 90 (92). This can prevent the center shaft 70 from coming off from the reclining apparatus 200 without using other members. Thus, the number of parts in the reclining apparatus 200 can be reduced, as a result of which the cost of the reclining apparatus 200 can be reduced.

Meanwhile, the reclining apparatus according to another aspect of the present invention may be expressed as a reclining apparatus attached to a seat cushion on which an occupant sits, a seat back inclinable with respect to the seat cushion, a seat back bracket attached to the seat back, and a seat cushion bracket attached to the seat cushion, and capable of fixing the seat back to the seat cushion at an angle to each other, wherein a shaft inserted through the reclining apparatus to enable manipulation of the reclining apparatus is provided with an annular protrusion, which is configured to be sandwiched between the reclining apparatus and either the seat back bracket or the seat cushion bracket.

According to this aspect, the shaft to manipulate the reclining apparatus is provided with the annular protrusion, which is arranged to be sandwiched between the reclining apparatus and either the seat back bracket or the seat cushion bracket. This can prevent the shaft from coming off without using other members. This leads to reduction in the number of parts and cost reduction.

Also, according to this aspect, it is possible to provide a reclining apparatus for a vehicle seat achieving improvement in attachment ability, cost reduction, and weight reduction.

While the invention has been illustrated and described in detail, the foregoing description is in all aspects illustrative and not restrictive. It is therefore understood that numerous modifications and variations can be devised without departing from the spirit and scope of the invention.

What is claimed is:

1. A reclining apparatus which adjusts an angle of a seat back with respect to a seat cushion, comprising:
a base plate fixed on a bracket of either the seat back or the seat cushion;
a gear mechanism which fixes the seat back to the seat cushion; and
a center shaft extending through the base plate and the gear mechanism to control fixing of the seat back by the gear mechanism and its release,
wherein the center shaft has an annular protrusion arranged to be sandwiched between the base plate and the bracket.

2. The reclining apparatus according to claim 1,
wherein the gear mechanism includes:
a gear plate having an internal gear, fixed on the other bracket of the seat back or the seat cushion, and rotatably attached to the base plate;
two pairs of fixing guides provided on the base plate;
a lock gear having an external gear and provided to be slidable to a position to be meshed with the gear plate between the pairs of fixing guides;
a cam which is provided to be rotatable while abutting on the lock gear, and controls a position of the lock gear; and
a spring which biases, and thus rotates, the cam to keep a state where the lock gear is meshed with the gear plate,
wherein the center shaft is coupled with the cam, and
rotation of the center shaft causes the cam to be rotated against a biasing force of the spring and releases mesh of the lock gear with the gear plate.

3. The reclining apparatus according to claim 2, wherein the gear mechanism further includes a link plate provided to be rotated simultaneously with the cam and pulling the lock gear inward when the mesh of the lock gear with the gear plate is released.

4. The reclining apparatus according to claim 2, wherein a mechanical strength of the fixing guide is set lower than those of the gear plate and the lock gear, and
when a large load is input to the reclining apparatus, the fixing guide is thrust and deformed by the lock gear, and an outer end portion of the fixing guide abuts on the internal gear of the gear plate.

5. The reclining apparatus according to claim 4, wherein the outer end portion of the fixing guide and a tip end of the internal gear of the gear plate are provided in proximity to each other, and
the outer end portion of the fixing guide digs into the internal gear of the gear plate when the fixing guide is deformed.

6. The reclining apparatus according to claim 4, wherein the fixing guide is formed to have a thickness to be substantially in a close contact state with the gear plate, and
when the fixing guide is deformed, deformation of the fixing guide in a thickness direction is suppressed by the gear plate.

7. The reclining apparatus according to claim 4, wherein the gear mechanism includes a link plate provided to be rotated simultaneously with the cam and pulling the lock gear inward when the mesh of the lock gear with the gear plate is released.

8. A vehicle seat comprising the reclining apparatus according to claim 1.
